(19) United States
(12) Patent Application Publication
(10) Pub. No.: US 2003/0050795 A1
(43) Pub. Date: Mar. 13, 2003

(54) Health care debt financing system and method

(76) Inventors: Byron S. Baldwin JR., Lincolnton, GA (US); Phillip Dolamore, Plantation, FL (US); Thomas Mahaney, Fort Lauderdale, FL (US)

Correspondence Address: Akerman, Senterfitt & Eidson, P.A., Post Office Box 3188, West Palm Beach, FL, 33402-3188, US

(21) Appl. No.: 09/951,261

(22) Filed: Sep. 12, 2001

(51) Int. Cl. G06F 17/60

(52) U.S. Cl. 705/2

(57) ABSTRACT

A patient health care financing method can include the steps of: computing fees and costs associated with specified health care services; obtaining credit information for the patient; and, issuing a health care consumer debt note for the patient for at least a portion of the computed fees and costs based on the obtained credit information. In one aspect of the invention, the portion of the computed fees and costs can include an uninsured portion of the requested health care services. Additionally, the patient health care financing method can include the step of determining a cash value for the consumer debt note; and, paying a provider of the specified health care services with funds which correspond to the determined cash value. Finally, the health care financing method can include the step of selling the health care consumer debt note to a third-party investor. Notably, in one aspect of the invention, the health care consumer debt note can be an installment note.

### BACKGROUND OF THE INVENTION

1. Technical Field

The present invention relates to the field of health care billing systems, and more particularly to financing health care treatment.

2. Description of the Related Art

Current methods employed by health care organizations in the qualification of applicants for health care financial assistance generally include the manual interpretation of demographic, health care and financial data. The interpretation of such data can include the comparison of the data with written guidelines provided by public and private agencies offering health care financial assistance through grants, tax fund programs, Medicaid and Medicare. Additionally many health care financial assistance programs require further interpretation of financial data such as those obtainable through conventional credit reporting. Still, the interpretive result can be characterized as having less than desirable accuracy.

Public and private financial assistance programs, of which there can be a dozens at any time, have proven helpful in defraying some expense experienced by health care providers in providing health care services to individuals of less than adequate means. The suitability of individual assistance programs, however, can vary depending upon the demographic, health care and financial data of each patient. Yet, identifying suitable financial assistance programs can be difficult in view both of the ever changing number and type of financial assistance programs, and the inaccuracies associated with interpreting the demographic, health care and financial data. In many cases, the successful identification of a suitable assistance program can depend on the experience, training and knowledge of individual admitting and billing clerks employed by the health care provider.

Part of determining the financial obligations of a patient can include the interpretation of demographic, health care and financial data. Generally, health care patients who have no outstanding debt are considered to be “self-pay patients”. The term, “self-pay patients” refers to those patients who lack health insurance and those patients who have insurance, but whose insurance includes a deductible or co-payment which exceeds the cost of proposed health care treatment. Self-pay patients also can include patients who can qualify for available financial assistance but fail to provide required documentation within an allowable time period which proves eligibility. Finally, self-pay patients can include those patients who seek elective procedures not covered by their respective health insurance plans, but nonetheless are of means to pay for the elective procedures.

Generally, although not absolutely, fees and costs accrued on behalf of a self-pay patient is considered an accounts receivable and, in consequence, those self-pay patients are billed as would be the case in any service oriented industry. Billing generally consists of the generation and submission of an invoice or bill, or multiple bills requesting of the self-pay patient payment in full. Where the self-pay patient can afford the invoiced services and costs, the self-pay patient can forward payment therefor. In contrast, where the self-pay patient cannot afford the invoiced services and costs, the associated receivables can be structured into a payment plan.

If a self-pay patient owing money to the health care provider fails to either pay an invoice in full, or structure a payment plan, the associated receivables can be transferred to a collection agency for further collection attempts. If the collection agency proves unsuccessful in efforts to collect on the receivable, the receivable can be deemed uncollectable and will appear on the credit report of the self-pay patient as a charge-off or collection and can generally be identified as a health care debt. This “invoice-to-collection” process can consume in excess of one year to complete.

Importantly, because the unpaid receivables are considered health care debt, patient confidentiality laws can apply which limit the extent to which a collection agency can prove the actual services rendered. Therefore, health care debts are difficult to enforce in the court system because of the lack of actual proof, other than a claim on the part of the health care provider that a debt actually exists. In consequence, a bloated charge structure has arisen to compensate for unpaid health care debt. To compound this problem, for every one dollar of health care expenses incurred by an insured patient, the patient's insurer likely will pay the health care provider between twenty-eight to thirty cents for that dollar. Alarmingly, the cost of providing that same health care care can approach twenty-eight cents for that same dollar. Hence, health care providers traditionally exaggerate the costs of basic health care care to compensate.

### SUMMARY OF THE INVENTION

A patient health care financing method can include the steps of: computing fees and costs associated with specified health care services; obtaining credit information for the patient; and, issuing a health care consumer debt note for the patient for at least a portion of the computed fees and costs based on the obtained credit information. In one aspect of the invention, the portion of the computed fees and costs can include an uninsured portion of the requested health care services. Additionally, the health care financing method can include the step of determining a cash value for the consumer debt note; and, paying a provider of the specified health care services with funds which correspond to the determined cash value. Finally, the health care financing method can include the step of selling the health care consumer debt note to a third-party investor. Notably, in one aspect of the invention, the health care consumer debt note can be an installment note.

Importantly, the determining step can include the step of determining the value at least in part based upon the obtained credit information. Moreover, the determined cash value can be less than the computed fees and costs. The paying step can include the step of paying the health care provider prior to the selling step. Conversely, the paying step can include the step of paying the health care provider after the selling step. The selling step can include the steps of: bundling a plurality of the health care consumer debt notes; and, selling the bundle of notes to the third-party investor. Finally, the method also can include the step of accepting repayment of the note by the patient by automatically transferring funds from a cash account of the patient to a cash account of the health care provider.

The patient health care financing method also can include the step of classifying the patient into one of at least four credit groups based upon the obtained credit information. The classifications can include four classification groups, each of the groups having no more than about 20% of the patients. Alternatively, the four classification groups can include a group of those patients having the poorest credit information comprises about 35% of the patients, and three classification groups having a substantially equal number of patients.

A health care financing system can include an interactive patient data collection interface for collecting demographic data associated with a health care patient, a credit worthiness data presentation screen for presenting credit history data electronically sourced from external credit information systems, and a credit report interface for reporting credit qualification data and notable credit related events based on the electronically sourced credit information. The patient data collection interface can include editable text fields for collecting patient data, guardianship data, health care services, fees and costs data, and demographic data. The patient data collection interface also can include read-only text fields for presenting health care debt financing data. Finally, the health care financing system can include an estimated charges applet for computing fees and costs associated with selected health care services, wherein the computed fees and costs data can be presented in the editable text fields of the interactive patient data collection interface.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic diagram of a health care financing system according to the invention.

FIGS. 2A-2D are exemplary screen shots depicting a user interface to the health care financing system of FIG. 1.

FIG. 3 is a flow diagram illustrating a health care financing method of the invention.

### DETAILED DESCRIPTION OF THE PREFERRED EMBODIMENTS

The present invention is a system and method for financing health care. The system and method can first compute those fees and costs associated with health care services provided to a patient by a health care provider. Once the fees and costs have been computed, the credit worthiness of the patient can be determined. Based on the determined credit worthiness of the patient, a health care consumer debt note can be generated for the patient for at least a portion of the debt. The consumer debt note can be used to support the payment of the health care provider for the anticipated health care services. Moreover, because the consumer debt note is a negotiable instrument, the consumer debt note can be converted to cash in the market for consumer debt. In this way, unlike routine medical debt, health care provider can recover a substantially greater portion of those fees owing to health care services provided to self-pay patients.

The term “health care provider” is used generally to mean all service providers and providers of goods that are necessary or desirable to furnish health care goods/services to a patient. Thus, the term includes service providers such as doctors, hospitals, therapists, counselors, and the like, without limitation. The term further encompasses purveyors of pharmaceuticals, rehabilitation equipment, and all other goods necessary for the treatment or well-being of a patient. Many of these goods/services are covered by insurance programs and government assistance programs, such as Medicare/Medicaid. However, in some instances, services are not covered or the amount of coverage is less than the amount owed. In the case of complicated hospital procedure and expensive pharmaceuticals, the unpaid portion can be significant.

The associated fees and costs associated with health care services can be computed based upon anticipated health care services, completed health care services, or both. In many cases, the system can compute the fees and costs during an admission process such as the admissions process conventionally implemented in a hospital or in the office of a typical physician. In those cases where health care services are provided prior to a formal admissions process, the associated fees and costs can be computed at least partially based upon those health care services provided prior to the admissions process.

Once the fees and costs have been computed, the credit worthiness of the patient can be determined. Though the credit worthiness step of the process can be initiated in limitless ways, in a typical aspect of the present invention, credit information for the patient can first be obtained upon receipt of an application for health care credit during the admissions process. Methods for obtaining credit information are well-known and available commercially through credit information providers. For instance, many credit information, for a fee, maintain electronically accessible databases of credit information for individuals and can be obtained with patient identifying information such as name, address, and social security number.

The information that is maintained and reviewed by the credit provider can vary with the credit information provider, however, the information will usually include the payment history supplied by companies who have extended credit to the patient. The information includes whether payment was made, whether installment payments were late or interrupted, and whether there was any default on the loan. It is also within the invention to maintain an independent database giving the credit history of a patient in repaying health care consumer debt notes issued according to the invention.

The credit information can include a credit rating issued by the credit information provider. This rating can be used in the invention, or a separate rating can be calculated particularly for the invention. For example, such rating system would classify patients into rating categories by the number of the late-pay events in the credit history, over a selected period of time. In one embodiment, those patients having less than 20% of credit report items being derogatory are given the highest or “A” rating. Those patients with less than 35% of credit report items being derogatory are issued a “B” rating. Those patients with less than 60% of credit report items being derogatory are issued a “C” rating. Finally, those with more than 60% of credit report items being derogatory are issued the lowest, a “D” rating.

The selected time period for rating the credit worthiness of patients can be varied, but in one embodiment is twelve months. Other credit events such as collections, charge-offs, judgments, and bankruptcies would also be considered in obtaining the credit rating. The proportion of patients in each category can be arbitrary or the results divided such that no class out of the four has less than 20% of the patients. In one aspect, the lowest credit rating would be maintained approximately 35% of the patients, while the remaining patients would be substantially evenly divided between the A, B, and C classes.

Based on the determined credit worthiness of the patient, a health care consumer debt note can be generated for execution by the patient for at least a portion of the debt be it anticipated or realized debt. The execution of the note can take place in the form of a written document that is printed for physical execution by the patient. The invention can also be performed using electronic signatures of the patient. The form and substance of the note can vary according to the amount of the note, the particular payment schedule of the note, and the like. The note can provide for any suitable repayment schedule, including installment notes, installment with balloon payment, revolving credit payments and credit lines, and the like. It is anticipated that, given the variety of patients' circumstances, services, and fees, many different consumer notes would be suitable for different particular circumstances.

Notably, in one aspect of the invention, the health care consumer debt note can be issued to the patient by an intermediate party and converted to an alternative asset type such as cash on the open market. For example, the note can be sold by the intermediate party to a lending institution in a manner which is analogous to the transfer of an auto loan or mortgage. Alternatively, in another aspect of the invention, the note can be issued to the patient directly by a lending institution.

The manner by which the health care consumer debt note can be sold can vary. In one aspect, the notes are sold on an individual basis. In another aspect, the notes are sold by means of an Internet-based electronic auction. In still another aspect, the notes are bundled and sold to an investors who purchase all or a portion of the bundled notes. Methods of bundling notes and of selling the same are known in the debt finance industry. In one aspect, the sale of the notes is conducted through an electronic sale mechanism, together with an electronic funds transfer system.

The health care provider can be paid for the debt ultimately by the lender that purchases the health care consumer debt note. It is within the invention, however, that the health care provider will be paid before or after the note is sold. It is further contemplated that the payment of installments by the patient to the lender could be accomplished by electronic funds transfer mechanisms.

Importantly, the sale of the note can be conditioned upon a recourse agreement. The recourse agreement is a guarantee which specifies that if the note that has been purchased goes into default or if the associated debtor fails to pay some or all of the due payments at all for a certain period of time, then the purchaser of the note can return the note to the health care organization in exchange for which the purchaser can receive the original amount paid for the note along with interest for the time the note had been outstanding. In essence, the recourse is a guarantee of the principle and interest by the health care organization. In the case of a public hospital, which often can be a taxing entity, the recourse agreement can be particularly important. That is, the underlying guarantee can induce note purchasers to underwrite the installment loans which otherwise would be extremely difficult to fund or convert into securities.

The invention further contemplates a health care financing system. The health care financing system can be used to compute those fees and costs associated with health care services provided to a patient by a health care provider, to determine the credit worthiness of the patient, and to generate a consumer debt note for the patient for at least a portion of the computed fees and costs. The system also can convert the consumer debt note to cash in the market for consumer debt by electronically presenting the note to one or more third-party lenders.

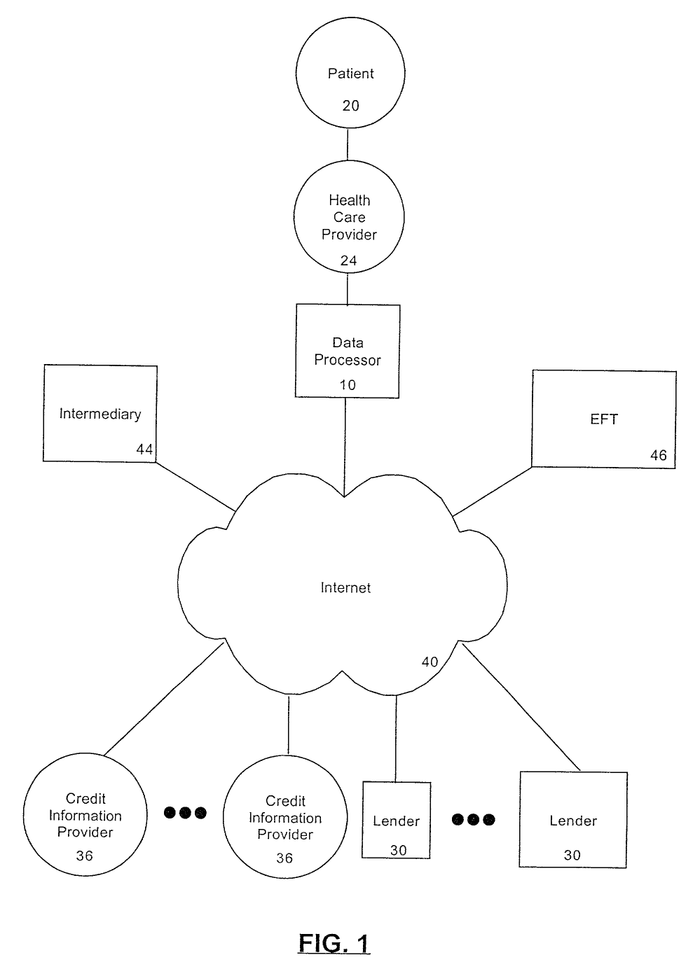

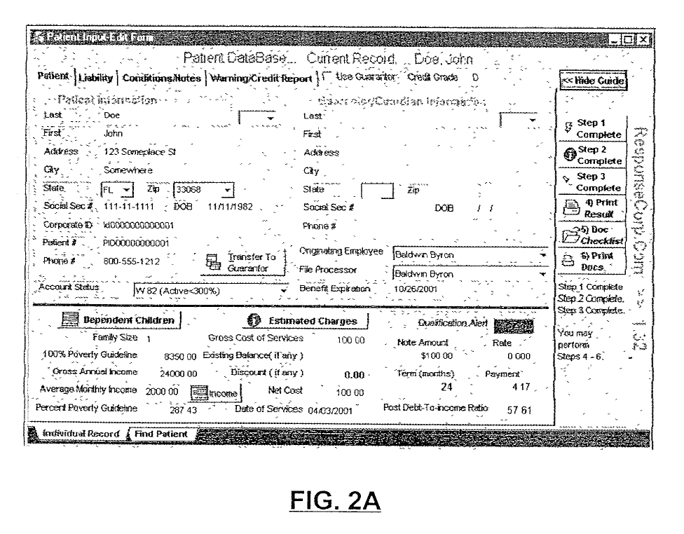

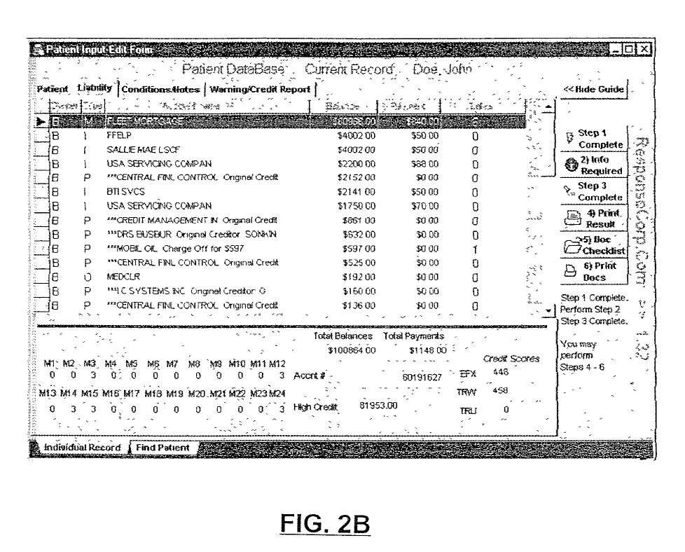

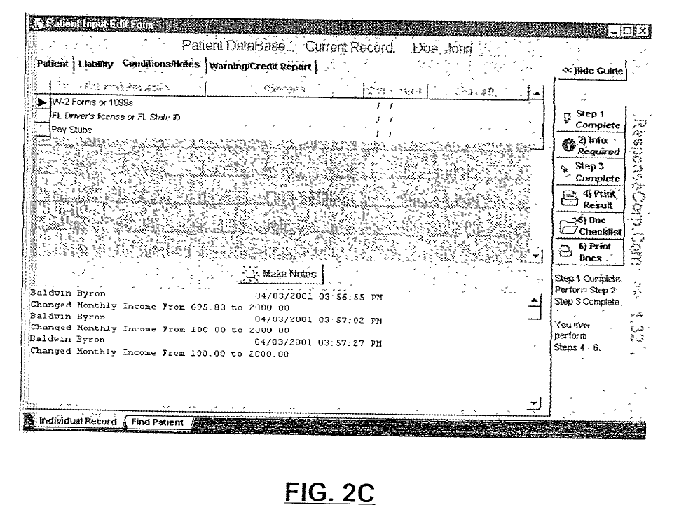

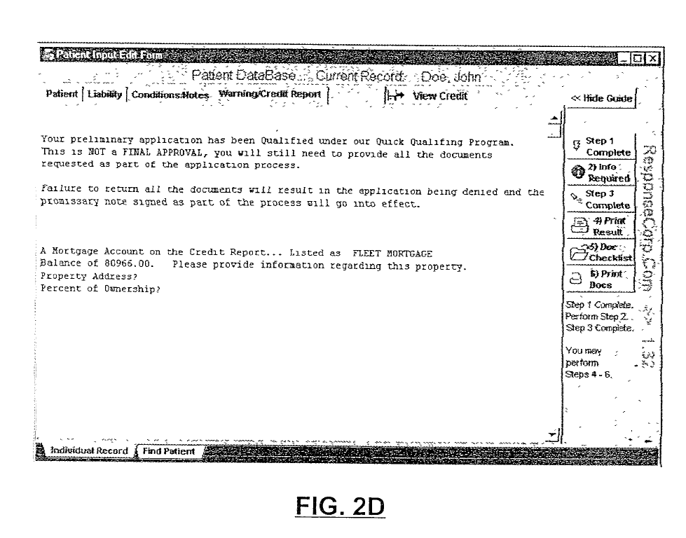

A system according to the invention is shown in FIG. 1. In the system, a patient 20 can request health care services at the offices of a health care provider 24. Alternatively, the patient 20 can request health care services prior to visiting the offices of the health care provider 24, for instance through a Web interface. Finally, in many cases, health care services can be provided prior to the patient's request. In any case, at the time of the request, the health care provider 24 can collect patient data, for instance basic patient identity information, guardianship information, family information, and requested services information. The collected information can be provided to health care financing data processor 10. More particularly, the health care provider 24 can interact with the financing data processor 10 via a user interface such as that illustrated in FIGS. 2A-2D.

FIG. 2A is a screen shot of an interactive patient data collection interface for collecting demographic data associated with a health care patient. The patient data collection interface can include editable text fields for collecting patient data, guardianship data, health care services, fees and costs data, and demographic data. The patient data collection interface also can have read-only text fields for presenting health care debt financing data. Notably, an estimated charges applet can be included for computing fees and costs associated with the selected health care services. The computed fees and costs can be based on the entirety of health care services requested, or only a portion of the services requested, for example that portion not already covered by an applicable health care insurance policy or available governmental and private aid.

FIG. 2B is a screen shot of a credit worthiness data presentation screen for presenting credit history data electronically sourced from external credit information systems. FIG. 2C is a screen shot of a credit conditioning and notes interface in which credit can be preconditioned on the satisfaction of one or more criteria. The credition conditioning and notes interface also can provide editable fields for adding operator notes associated with the credit request. Finally, FIG. 2D is a screen shot of a credit report interface for reporting credit qualification data and notable credit related events based on said electronically sourced credit information.

Returning now to FIG. 1, once the request has been received, the credit worthiness of the patient 20 can be determined by electronically collecting credit data from credit information systems 36 communicatively linked to the health care financing data processor 10. The credit worthiness can be determined using conventional methods known in the financing and lending art for example as is normally employed in processing auto loans or consumer credit applications. The determined credit worthiness data can be visually presented to the health care provider 24 via a credit worthiness screen in the health care financing data processor 10. Additionally, a credit report can be displayed through a credit report interface for reporting credit qualification data and notable credit related events based on the electronically sourced credit information.

Using the credit qualification data presented through the credit report interface, the health care provider 24 can decide whether or not to extend credit to the patient 20. Alternatively, the decision can be processed automatically by the health care financing data processor 10 using artificial intelligence processing well-known in the art. If it is determined that credit can be extended to the patient 20, a health care consumer debt note can be prepared and generated based on the computed fees and costs, patient data and credit worthiness data. The patient 20 can execute the note, either physically or electronically, subsequent to which the selected health care services can be provided.

Once the note has been executed, funds can be advanced to the health care provider 24 based on the computed fees and costs and the amount financed by the patient 20 as indicated by the executed note. The funds can be transferred conventional via post, or electronically, for instance via electronic funds transfer. Importantly, the health care system can be configured using a topology in which the health care provider 24 interacts directly with a third-party lender 30. In that case, the consumer debt note can be executed by and between the lender 30 and the patient 20.

The lender 30, in turn, can forward funds guaranteed by the note to the health care provider 24. In another aspect of the invention, however, an intermediary 44 can initially process and underwrite the consumer debt note. Once underwritten, the intermediate lender 44 can sell the note to third-party investors such as the lender 30 at a discounted rate based upon the credit worthiness of the patient 20. Finally, in yet another aspect of the invention, the intermediary 44 can merely auction the requested note to one or more lenders 30 in a manner analogous to the online mortgage lending market. In that case, the intermediary 44 can collect a commission for originating the note.

As previously discussed, the value of the note can be determined based in part upon the credit rating of the patient 20. Further, while lenders 30 can purchase a single note, it is anticipated that many notes will be bundled together as packages for convenience and bought and sold as is known in the debt finance industry. The health care provider 24 is paid from funds derived from the sale of the health care consumer debt note, although it is within the invention that the health care provider 24 can be reimbursed prior to the sale of the note to a lender 30.

The operation of the invention can occur through any suitable medium, including the mail, phone lines, satellite transfer, and the like. It is anticipated, however, that the invention will be performed through a global computer information network such as the Internet 40. Funds transfer can thereby be accomplished by a suitable electronic funds transfer agent 46. The electronic funds transfer agent 46 is known to the art and can be a bank, lending institution, credit institution, or the like.

The amount charged for a health care consumer debt note according to the invention will vary according to the amount of the debt, the credit rating of the consumer, and the like. As discussed above, the invention contemplates the division of patients into at least four credit rating categories—A, B, C, and D. For example only, and without limitation, in the case of an “A” rating, the health care consumer debt note might sell for 0.55¢ per dollar of debt. A “B” credit rating might sell for 0.40¢ per dollar of debt. A “C” credit rating might sell for 0.25¢ per dollar. A “D” credit rating, evidencing no credit, would be purchased only for a share of any possible recovery.

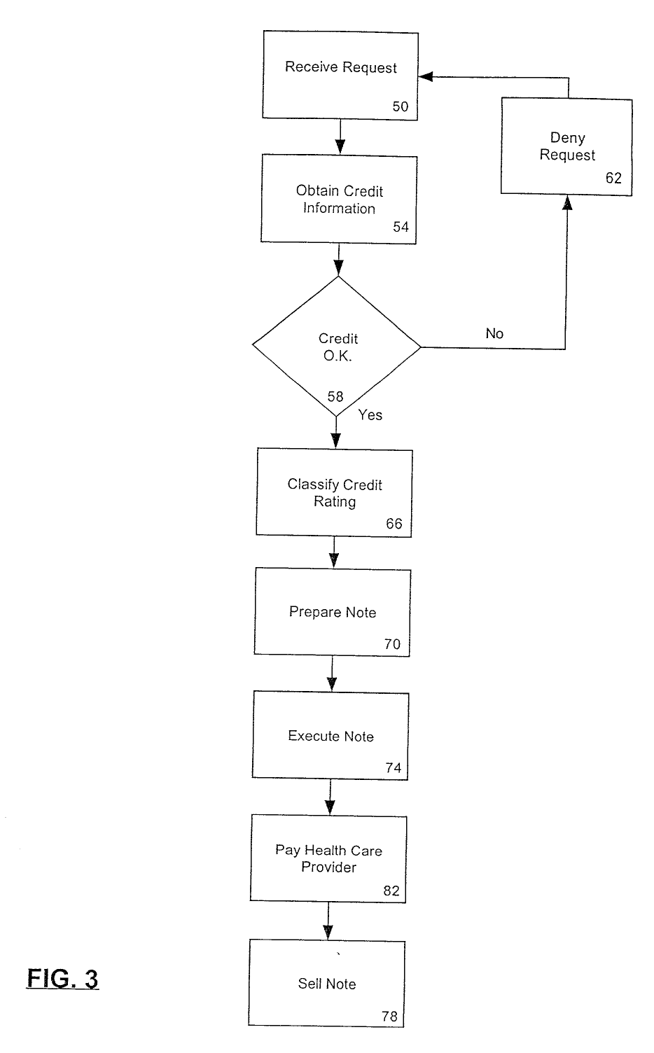

The method of the invention is illustrated in FIG. 3. A request for health care debt financing is received in step 50. Credit information is obtained in step 54. A determination is made regarding whether the credit of the patent is acceptable in step 58. If not, financing is denied in step 62. If the financing is acceptable, the credit of the patient is classified in a step 66. A health care consumer debt note is prepared in step 70. The note must be executed in step 74. The note is sold in step 78, and the health care provider is paid in step 82.

Notably, the method of the invention as shown in FIG. 3 can be realized in hardware, software, or a combination of hardware and software. The method of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The method of the invention can also be embedded in a computer program product, which comprises all the features enabling the implementation of the methods described herein, and which when loaded in a computer system is able to carry out these methods. Computer program means or computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the foregoing specification illustrates and describes the preferred embodiments of this invention, it is to be understood that the invention is not limited to the precise construction herein disclosed. The invention can be embodied in other specific forms without departing from the spirit or essential attributes. Accordingly, reference should be made to the following claims, rather than to the foregoing specification, as indicating the scope of the invention.

We claim:

1. A patient health care financing method, comprising the steps of:
computing fees and costs associated with specified health care services;
obtaining credit information for the patient; and,
issuing a health care consumer debt note for the patient for at least a portion of said computed fees and costs based on said obtained credit information.

2. The patient health care financing method of claim 1, further comprising the step of:
determining a cash value for said consumer debt note; and,
paying a provider of said specified health care services with funds which correspond to said determined cash value.

3. The patient health care financing method of claim 1, further comprising the step of:
selling said health care consumer debt note to a third-party investor.

4. The patient health care financing method of claim 2, further comprising the step of:
selling said health care consumer debt note to a third-party investor.

5. The patient health care financing method of claim 2, wherein said determining step comprises the step of:
determining said value at least in part based upon said obtained credit information.

6. The patient health care financing method of claim 2, wherein said determined cash value for said consumer debt note is less than said computed fees and costs.

7. The patient health care financing method of claim 4, wherein said paying step comprises the step of:
paying said health care provider prior to said selling step.

8. The patient health care financing method of claim 4, wherein said paying step comprises the step of:
paying said health care provider after said selling step.

9. The patient health care financing method of claim 1, further comprising the step of:
classifying the patient into one of at least four credit groups based upon said obtained credit information.

10. The patient health care financing method of claim 9, wherein said classifications comprise four classification groups, each of said groups having no more than about 20% of said patients.

11. The patient health care financing method of claim 9, wherein a classification group of those patients having the poorest credit information comprises about 35% of said patients, and the remaining three classification groups comprise substantially equal numbers of patients.

12. The patient health care financing method of claim 1, wherein said portion of said computed fees and costs comprises an uninsured portion of said specified health care services.

13. The patient health care financing method of claim 1, wherein said selling step comprises the steps of:
bundling a plurality of said health care consumer debt notes; and,
selling said bundle of notes to said third-party investor.

14. The patient health care financing method of claim 1, wherein said health care consumer debt note is an installment note.

15. The patient health care financing method of claim 1, further comprising the step of:
accepting repayment of said note by said patient by automatically transferring funds from a cash account of said patient to a cash account of said health care provider.

16. The patient health care financing method of claim 3, further comprising the step of:
by conditioning said sale upon a recourse agreement.

17. A health care financing system comprising:
an interactive patient data collection interface for collecting demographic data associated with a health care patient, said patient data collection interface comprising editable text fields for collecting patient data, guardianship data, health care services fees and costs data, and demographic data, and read-only text fields for presenting health care debt financing data;
a credit worthiness data presentation screen for presenting credit history data electronically sourced from external credit information systems; and,
a credit report interface for reporting credit qualification data and notable credit related events based on said electronically sourced credit information.

18. The health care financing system of claim 17, further comprising:
an estimated charges applet for computing fees and costs associated with selected health care services, wherein said computed fees and costs data can be presented in said editable text fields of said interactive patient data collection interface.

19. A machine readable storage, having stored thereon a computer program for financing patient health care, said computer program having a plurality of code sections executable by a machine for causing the machine to perform the steps of:
computing fees and costs associated with specified health care services;
obtaining credit information for the patient; and,
issuing a health care consumer debt note for the patient for at least a portion of said computed fees and costs based on said obtained credit information.

20. The machine readable storage of claim 19, further comprising the step of:
determining a cash value for said consumer debt note; and,
paying a provider of said specified health care services with funds which correspond to said determined cash value.

21. The machine readable storage of claim 19, further comprising the step of:
selling said health care consumer debt note to a third-party investor.
